(19) United States
(12) Patent Application Publication
(10) Pub. No.: US 2024/0347949 A1
(43) Pub. Date: Oct. 17, 2024

(54) CONTACTING ASSEMBLY

(71) Applicant: ENNOVI ADVANCED ENGINEERING SOLUTIONS GERMANY GMBH, Heibronn (DE)

(72) Inventor: Hans-Joerg HAHN, Pforzheim (DE)

(21) Appl. No.: 18/294,982

(22) PCT Filed: Jun. 24, 2022
(86) PCT No.: PCT/EP2022/067373

§ 371 Date: Feb. 2, 2024

(30) Foreign Application Priority Data
Aug. 4, 2021 (DE) 102021120307.4

(51) Int. Cl. H01R 13/115; H01R 12/58; H01R 12/71; H01R 13/05

(52) U.S. Cl. CPC H01R 13/115; H01R 12/58; H01R 12/718; H01R 13/055

(57) ABSTRACT

A multipart contacting assembly has at least two substantially flat contact plates with flat faces that provide contacting zones having contact elements extending from the lateral edge for contacting mating contacts, and a contact cage which is bent in a substantially U-shaped or V-shaped manner having a base section and two opposing contact arms protruding therefrom. The contact cage provides two respective contact ribs running next to one another in pairs for each contact plate, thereby forming a press-in gap with press-in zones which are situated opposite one another in pairs, wherein each press-in zone is oriented toward the press-in gap so that the two contacting zones of each contact plate are fixed between press-in zones in a form- and force-fitting manner in the assembled state, and wherein the free end of each contact arm of the contact cage has an inner contact zone for contacting another contact element.

### RELATED APPLICATIONS

This application claims priority to and is a 35 U.S.C. § 371 national phase application of PCT/EP2022/067373, filed Jun. 24, 2022, and claims priority to German Patent Application No. 10 2021 120 307.4, filed Aug. 4, 2021, the entire contents of each of which are incorporated herein by reference in their entirety.

### FIELD

The disclosure relates to a contacting assembly for contacting a contact carrier, particularly of a printed circuit board or a PCB application, particularly in which high currents can be transmitted.

### BACKGROUND

Contact press-in elements are known from DE 198 31 672 A1 and DE 197 26 856 C1 which consist of a particularly tin-plated stamped and bent part which is particularly made of a copper alloy. The press-in elements have different plug geometries or contact geometries in order to be able to establish an electrical conductive connection with knife contacts, contact zones of a circuit board, contacts of a plug connection, or the core of a cable. The contact press-in elements are attached to a contact carrier through pressing-in. The contact carrier is a circuit board, particularly one made of a glass fiber-reinforced plastic, which is laminated at least on one side with a copper coating. One or more openings with a round cross section are drilled in the contact carriers. Contact sleeves are inserted into the openings. Press-in pins of the contact press-in elements such as those described in DE 198 31 672 A1 are inserted into the contact sleeves. By slitting the press-in pins in their extension direction, two contact legs running parallel to one another are formed. The latter are bent apart so that two outwardly curved contact legs are formed. The curved contact legs can be bent elastically toward one another. When the contact pin is pressed into the contact opening with which it is associated, the contact legs are pressed together. They rest in frictional, electrically conductive contact against the inner wall of the sleeve, which forms contact surfaces in the surface contact area. Such a press-in connection has manufacturing advantages because it is a solderless connection of a press-in element to a contact carrier. Such press-in connections are increasingly being used in motor vehicle construction and other energy transmission applications. There, high currents are transmitted via electrical conductor assemblies having this design.

Contact press-in elements are known from DE 10 2004 006 575 A1 which are pressed into lead frames made of metal. It is disadvantageous that, particularly with thin-walled lead frames, the contact surfaces for the transmission of high currents are too small, and a high level of mechanical stability is not achieved.

DE 20 2009 009933 U1 relates to an electrical conductor assembly with an electrically conductive contact carrier having at least one contact opening and with a contact press-in element having a press-in pin that is pressed into the contact opening, the press-in pin having contact legs which are curved away from one another transversely to the direction of longitudinal extension thereof and can be bent elastically toward one another which, when the press-in pin is pressed into the contact opening with which it is associated, are bent toward one another and, when in the pressed-in state, rest against oppositely situated contact surfaces of the inner wall of the contact opening in a non-positive, electrically conductive manner.

However, there is a need to provide improved and more flexible solutions, particularly for the transmission of high currents which make multiple connection options possible for different conductors and contact geometries while permanently ensuring a high current-carrying capacity with stable mechanical and electrical contacting despite wide temperature changes.

It is therefore the object of the disclosure to overcome the disadvantages known in the prior art and provide an optimized contacting assembly.

### BRIEF SUMMARY

The present disclosure provides a multipart, specifically shaped contacting assembly which, on the one hand, enables certain design properties of certain shapes and features to be used in a targeted manner and, on the other hand, makes a modular construction possible which enables various contacts to be connected thereto.

According to the disclosure, a multipart contacting assembly is provided which comprises at least one or at least two (and hence also three or more) substantially flat contact plates, the flat faces of which provide contacting zones and from the lateral edge of which contact elements for contacting mating contacts, in particular of an external contact carrier, extend away, as well as a contact cage which is bent in a substantially U-shaped or V-shaped manner and which is made of a base section and two opposing contact arms protruding from the base section, wherein the contact cage provides two respective contact ribs running next to one another in pairs for each contact plate, thereby forming a press-in gap with press-in zones which are situated opposite one another in pairs, wherein each press-in zone is oriented toward the press-in gap so that the two contacting zones of each contact plate are fixed between press-in zones which are situated opposite one another in pairs in a form- and force-fitting manner in the assembled state (i.e., when pressed into the respective press-in gap of the contact cage), and wherein the free end of each contact arm of the contact cage has an inner contact zone for contacting another contact element.

The contact cage provides two specifically shaped press-in zones for each contact plate which are formed by the contact ribs which are situated next to one another in pairs, so that a respective contact plate can be pressed into these zones and the flat sides of the contact plates are then held in contact between the press-in zones. For this purpose, the contact ribs are preferably designed to be resilient and elastically deformable, at least partially elastically.

One preferred embodiment of the disclosure makes a provision that the two contact plates have a central recess which extends from the upper side edge in the direction of the lower side edge (the side edge with the contact elements) and particularly forms the inner side edge which runs transversely to the two abovementioned side edges a support for the base section. As soon as the contact plates are pressed into the press-in zones of the contact cage, the base section then rests on the support in the recess.

In another preferred embodiment of the disclosure, a provision is made that the recess in the contact plate is embodied as a recess with a substantially rectangular cross section or an approximately T-shaped or hammer-shaped cross section.

In a preferred embodiment of the disclosure, a provision is also made for this purpose that a respective connecting web of the base section connecting the two contact ribs which are situated next to one another in pairs rests on the support of the respective contact plate as an abutment when the contact plate is in its assembled, pressed-in state.

Another embodiment of the disclosure makes a provision that the contact cage has a central connecting web between the contact ribs which are arranged next to one another in pairs which extends from one free end of one contact arm along the base section to the other free end of the oppositely situated contact arm.

It is also advantageous if the contact zones for contacting a mating contact element are situated opposite one another at (or close to) the free end of the resilient contact arms and are each embodied as a curved web which has a linear contact zone (at its crest line). A correspondingly shaped contact element can then be inserted between the two contact zones, with the effect that the two contact arms spring apart and rest against the mating contact with their linear contact zone under spring force. In this way, a substantially higher current carrying capacity is achieved compared to a punctiform system.

A provision is also advantageously made that the contact elements protruding in one piece on the contact plates are embodied as press-in contacts with two oppositely situated spring arms which are preferably connected on the insertion side. It is also preferred that two contact elements be provided on each contact plate.

Another embodiment of the disclosure makes a provision that the press-in gap between the respective two contact ribs that are arranged in pairs next to one another has the shape of an hourglass or is tapered in the middle in the area of the oppositely situated press-in zones, in that the opposing contact ribs are initially spaced farther apart from one another at the ends and then run toward each other to the area of the press-in zones, whereby the gap width narrows and the contact ribs are spaced farther apart from one another in the further course.

One embodiment in which the two contact arms are each connected to the base section via a curved transition section and the press-in gap preferably extends from the spring arms into the base section.

Furthermore, a provision may be made that the two contact plates each have external shoulders with a flat top side. These can serve as supports or as mounting bearings.

In some embodiments the two contact plates each form on the side edge (lower side edge) having the contact elements a support for resting on a contact carrier or circuit board, thereby defining or limiting the press-in depth of the contact elements into the contact zones provided for this purpose on the contact carrier or circuit board.

One preferred embodiment of the disclosure makes a provision that the width of the base section corresponds substantially to the width of the contact arms, so that the envelope contour of the contact cage is substantially cuboid or tent-shaped.

Other advantageous refinements of the disclosure are depicted in greater detail below together with the description of the preferred embodiment of the disclosure with reference to the figures.

### BRIEF DESCRIPTION OF THE DRAWINGS

FIG. 1 shows an exemplary perspective view of the parts of an exemplary embodiment of a multipart contacting assembly;

FIG. 2 shows a perspective view of the contacting assembly according to FIG. 1 in the assembled state;

FIG. 3 shows a perspective view of the contacting assembly according to FIG. 2 with an inserted mating contact;

FIG. 4 shows an exemplary perspective view of the parts of an alternative embodiment of a multipart contacting assembly;

FIG. 5 shows a perspective view of the contacting assembly according to FIG. 4 in the assembled state;

FIG. 6 shows a perspective view of the contacting assembly according to FIG. 5 with an inserted mating contact; and

FIG. 7 shows an embodiment with only one contact plate.

### DETAILED DESCRIPTION

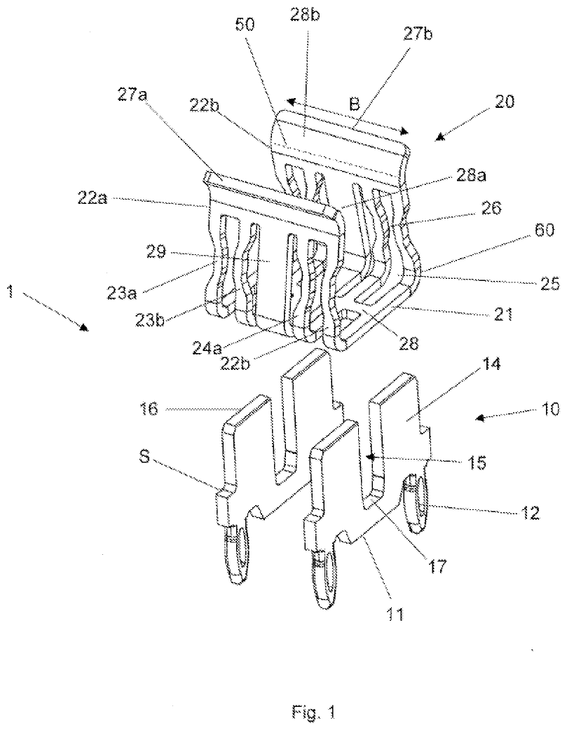

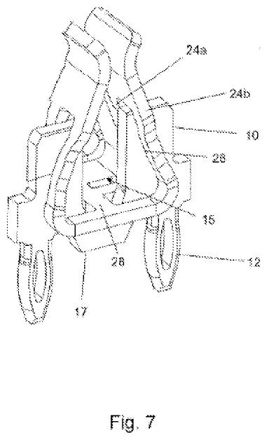

In the following, the disclosure will be explained in greater detail with reference to FIGS. 1 to 7, with same reference symbols in the figures referring to similar structural and/or functional features.

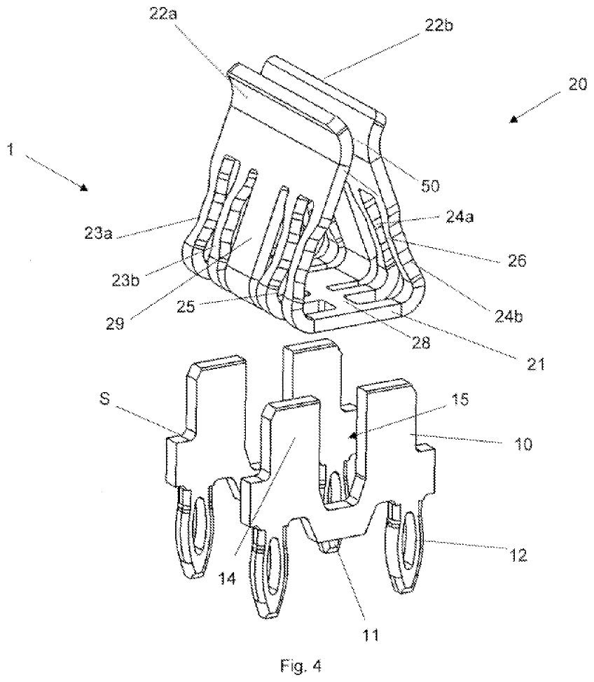

FIGS. 1 and 4 show exemplary perspective views of the parts of two exemplary embodiments, each of a multipart contacting assembly 1. The contacting assembly 1 comprises two flat contact plates 10, the front and rear end faces 12 of which each have flat contacting zones 14.

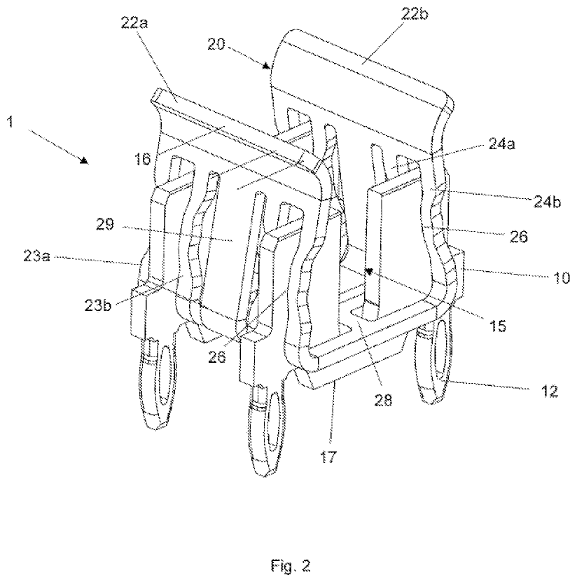

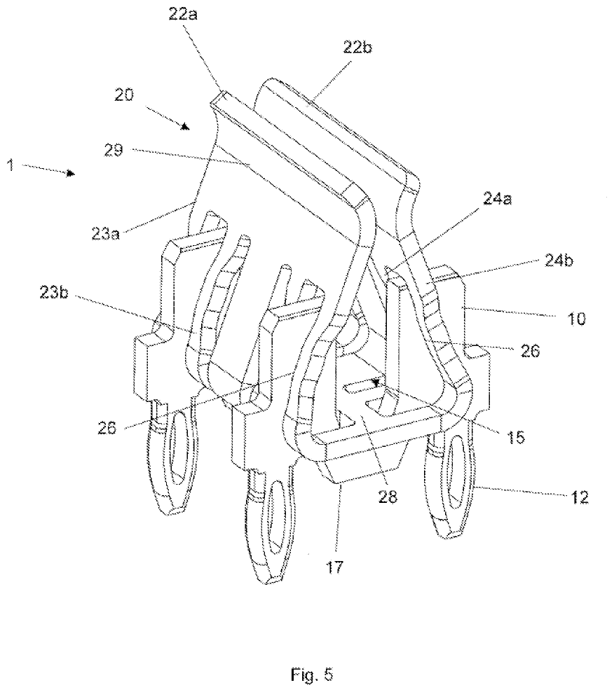

FIGS. 2 and 5 each show perspective views of the parts of the two exemplary embodiments of FIGS. 1 and 4 in the assembled state.

Contact elements 12, particularly press-in contacts 12 for pressing into contact zones on the circuit board side (generally, mating contacts), extend from the lower side edge 11 of the two contact plates 10. The contact plates 10 each have external shoulders S.

Furthermore, the multipart contacting assembly 1 according to FIG. 1 has a U-shaped contact cage 20, and the contacting assembly 1 according to FIG. 4 has a V-shaped contact cage 20. In the V-shaped curved contact cage 20, the contact arms 22a, 22b run toward each other at an oblique angle and, compared to the U-shaped curved contact cage 20 from FIG. 1, form a smaller contact distance between the contact arms 22a, 22b at the end contact zone thereof. The contact cage 20 is respectively formed from a base section 21 and the two contact arms 22a, 22b protruding from the base section 21, and it is preferably formed as a stamped and bent part made of a high-performance copper alloy. The two contact plates 10 can also be made of this material. Due to the multipart design, however, these can also be made of a material that is optimized for the press-in zones or for the contact properties, which means high strength, good relaxation (heat resistance), and good spring properties at the same time. The width B of the base section 21 is substantially identical to the width B of the contact arms 22a, 22b.

For each contact plate 10, the contact cage 20 forms two contact ribs 23a, 23b, 24a, 24b which run next to one another in pairs. A gap, particularly a press-in gap 25, is formed between the two contact ribs 23a, 23b or 24a, 24b which run next to one another in pairs.

In the area of each contact arm 22a, 22b, the opposite contact ribs 23a, 23b and 24a, 24b each have press-in zones 26 which are situated opposite one another in pairs. The press-in zones 26 have their contact surfaces on the side flanks of the contact ribs 23a, 23b or 24a, 24b and are oriented, as it were, toward the press-in gap 25.

As soon as the contact plates 10 are pressed into the press-in gap 25 between the contact ribs 23a, 23b or 24a, 24b, the contacting zones 14 of the contact plates 10 contact the press-in zones 26 of the contact ribs 23a, 23b or 24a, 24b.

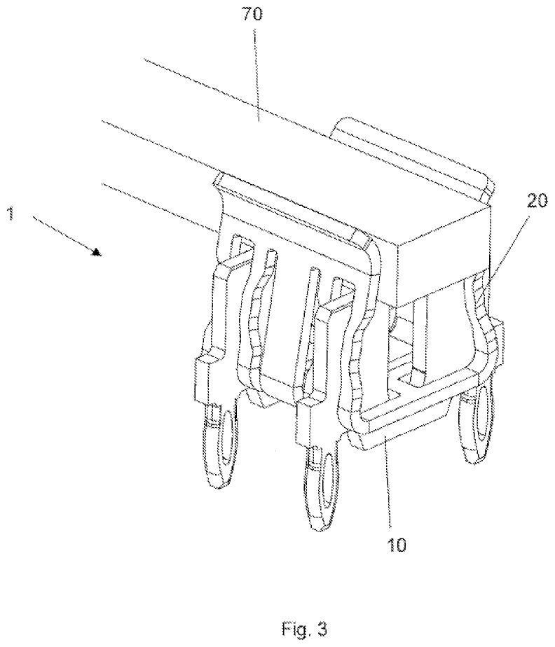

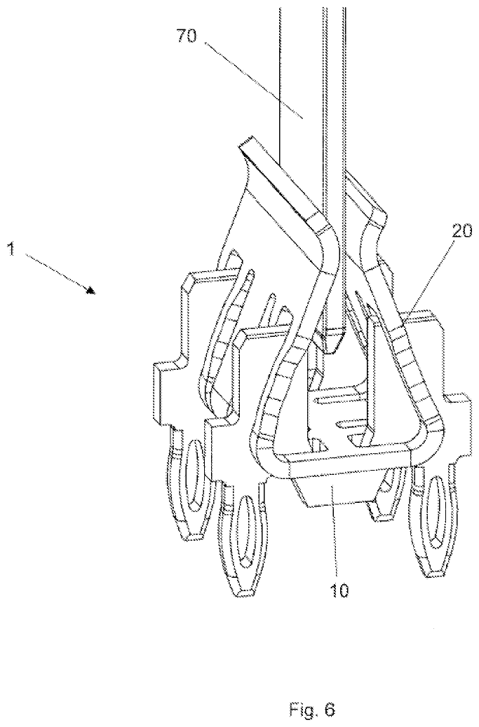

At each free end 27a, 27b of the contact arms 22a, 22b there is a contact zone 28a, 28b facing toward the respective other contact arm 22a, 22b. This area serves to accommodate a mating contact element, as is shown by way of example in FIGS. 3 and 6. A suitable contact receiving area is produced as a function of the geometric design of the pitch of the two contact arms 22a, 22b, and the contact force can be adjusted appropriately.

FIG. 3 shows a mating contact 70 which is received between the contact zones 28a, 28b, whereas in FIG. 6 a flat contact 70 is received from above into the area between the contact zones 28a, 28b. This means that different contact shapes and plug-in directions can be contacted.

The two contact plates 10 also have a central recess 15 which extends from the upper side edge 16 to the lower side edge 11. A transverse web remains which forms a support for the base section 21 of the contact cage 20 on its upper (inner) side edge 17. The recess 15 in the contact plate 10 has a substantially rectangular cross section. Alternatively, a T-shaped recess could also be provided.

The two contact ribs 23a, 23b and 24a, 24b which are situated next to one another in pairs have a connecting web 28 which runs transversely to the course of the contact ribs 23a, 23b or 24a, 24b. This connecting web 28 of the contact cage 20 serves as an abutment on the support 17 of the respective contact plate 10.

The contact cage 20 of these exemplary embodiments has a respective central connecting web 29 (central web) between the contact ribs 23a, 23b and 24a, 24b which are arranged next to one another in pairs. This central web 29 runs from one free end 27a of one contact arm 22a along the base section 21 to the other free end 27b of the oppositely situated contact arm 22b. Furthermore, there is a connecting web to the immediately adjacent contact ribs 23b and 24a, specifically in the area of the base section 21.

The contact zones 28a, 28b, which are situated opposite one another at the free end 27a, 27b of the contact arms 22a, 22b, are each embodied as a curved web that connects the contact ribs 23a, 23b and 24a, 24b to one another. As a result of the curvature or bend, the contact zones 28a, 28b form a linear contact zone in the area of the crest line 50 of the bend.

As can also be clearly seen in the figures, the contact ribs 23a, 23b or 24a, 24b do not run parallel in a straight line. Rather, these extend in such a way that the press-in gap formed between them has the shape of an hourglass, in that the opposing contact ribs 23a, 23b or 24a, 24b are initially spaced farther apart from one another at the ends (i.e., they have a larger gap width there), then run toward one another to the area of the press-in zones 26, thereby narrowing the gap width, and the contact ribs 23a, 23b or 24a, 24b are spaced farther apart from one another in the further course and run around the bend (the transition section 60) at approximately this distance until they reach into the base section 21.

The disclosure is not limited in its execution to the abovementioned preferred exemplary embodiments. Rather, a number of variants are conceivable which make use of the illustrated solution even in the form of fundamentally different embodiments.

1. A multipart contacting assembly, comprising:
at least one or at least two substantially flat contact plates, the flat faces of which provide contacting zones and having contact elements that extend from a lateral edge of the contact elements for contacting mating contacts of an external contact carrier, and
a contact cage which is bent in a substantially U-shaped or V-shaped manner and which is made of a base section and two opposing contact arms protruding from the base section, wherein the contact cage provides two respective contact ribs running next to one another in pairs for each contact plate, thereby forming a press-in gap with press-in zones which are situated opposite one another in pairs,
wherein each press-in zone is oriented toward the press-in gap so that the two contacting zones of each contact plate are fixed between press-in zones which are situated opposite one another in pairs in a form- and force-fitting manner in the assembled state, in which the contact plates are pressed into the respective press-in gap of the contact cage, and
wherein the free end of each contact arm of the contact cage has an inner contact zone for contacting another contact element.

2. The contacting assembly as set forth in claim 1, wherein the two contact plates have a central recess which extends from the side edge with the contact elements to the oppositely situated side edge and forms the an inner side edge which runs transversely to the two side edge a support for the base section.

3. The contacting assembly as set forth in claim 2, wherein the two respective contact ribs include a first pair and a second pair (24a, 24b) which are situated next to one another, have a connecting web running transversely thereto, each of which rests as an abutment on the support of the respective contact plate.

4. The contacting assembly as set forth in claim 1, wherein the two respective contact ribs include a first pair and a second pair arranged next to each other, and wherein the contact cage has a central connecting web between the first and second pairs of contact ribs which extends from one free end of one contact arm along the base section to the other free end of the oppositely situated contact arm.

5. The contacting assembly as set forth in claim 1, wherein the contact zones are situated opposite one another at the respective free end of the contact arms and are each embodied as a curved web which has a linear contact zone at its crest line.

6. The contacting assembly as set forth in claim 1, wherein the recess in the contact plate is configured as a recess with a substantially rectangular cross section or an approximately T-shaped or hammer-shaped cross section.

7. The contacting assembly as set forth in claim 1, wherein the contact elements on the contact plates are embodied as press-in contacts with two oppositely situated spring arms connected on the insertion side.

8. The contacting assembly as set forth in claim 1, wherein the two respective contact ribs include a first pair and a second pair arranged next to each other in the area of the opposite press-in zones, and wherein the press-in gap between the first and second pair of has the shape of an hourglass, in that the opposing first and second pairs of contact ribs are initially spaced farther apart from one another at the ends and then run toward each other to the area of the press-in zones, whereby the gap width narrows and the first and second pairs of contact ribs are spaced farther apart from one another in the further course.

9. The contacting assembly as set forth in claim 1, wherein the two contact arms are each connected to the base section via a curved transition section.

10. The contacting assembly as set forth in claim 1, wherein the two contact plates each have external shoulders with a flat top side.

11. The contacting assembly as set forth in claim 1, wherein the two contact plates each form, on the side edge having the contact elements, a support for supporting on a contact carrier or circuit board, thereby defining the press-in depth of the contact elements into the contact zones on the contact carrier or circuit board.

12. The contacting assembly as set forth in claim 1, wherein a width of the base section corresponds substantially to a width of the contact arms.
